(19) United States
(12) Patent Application Publication
(10) Pub. No.: US 2026/0084741 A1
(43) Pub. Date: Mar. 26, 2026

(54) STEERING COLUMN FOR A MOTOR VEHICLE

(71) Applicants: thyssenkrupp Presta AG, Eschen (LI); thyssenkrupp AG, Essen (DE)

(72) Inventors: Tim BAYER, Luechingen (CH); Chao LIU, Tettnang (DE)

(73) Assignees: thyssenkrupp Presta AG, Eschen (LI); thyssenkrupp AG, Essen (DE)

(21) Appl. No.: 19/338,809

(22) Filed: Sep. 24, 2025

(30) Foreign Application Priority Data
Sep. 25, 2024 (DE) 10 2024 127 842.0

(51) Int. Cl. B62D 1/185; B62D 1/181

(52) U.S. Cl. CPC B62D 1/185; B62D 1/181

(57) ABSTRACT

A steering column for a motor vehicle comprises an inner casing of an actuating unit, said inner casing being received so as to be telescopically adjustable in the longitudinal direction axially with respect to a longitudinal axis in a passage of an outer casing, there being fixed to the outer casing at least one sliding element on which the inner casing is slidingly mounted. In order to allow improved support and sliding function, the sliding element is designed in the form of a tube segment elongated in the longitudinal direction.

### CROSS REFERENCE TO RELATED APPLICATION

This application is a U.S. Non-Provisional that claims priority to German Patent Application No. DE 10 2024 127 842.0, filed Sep. 25, 2024, the entire content of which is incorporated herein by reference.

### FIELD

The present disclosure relates to a steering column for a motor vehicle.

### BACKGROUND

Such an adjustable steering column for a motor vehicle comprises an actuating unit having a steering spindle mounted rotatably about its longitudinal axis, a steering wheel for the introduction of manual steering commands being attached at that end of said spindle which is at the rear in the direction of travel and faces towards the driver. The actuating unit is received in an adjustable casing unit which is held by a carrying unit fastened to the vehicle body. An adjustment of the casing unit allows the position of the steering wheel relative to the vehicle body to be set.

A longitudinal adjustment, in which the steering wheel can be adjusted backwards or forwards relative to the driver's position in the longitudinal direction, i.e. in the longitudinal direction given by the longitudinal axis, is enabled by a telescopic configuration of the casing unit and of the steering spindle. Furthermore, in the event of a crash, the steering column can be pushed together in the longitudinal direction, as a result of which the steering column penetrating the interior of the passenger compartment and resulting in injuries to the occupants is effectively avoided.

The casing unit has at least two casings, which are synonymously also referred to as casing tubes. An inner casing, also referred to as inner casing tube, dips coaxially into a passage of an outer casing, which is also referred to as outer casing tube, and is telescopically guided therein in the longitudinal direction. The steering column can correspondingly be adjusted in the longitudinal direction by pushing together or pulling apart of the inner casing and outer casing. The casings are usually manufactured from metal. In order to allow a low-play linear bearing system and a smooth-running adjustment, it is known, for example from EP 2 990 300 B1, to insert a sliding element between the inner casing and the outer casing. This sliding element is fixed on the inside in the passage of the outer casing and lies in sliding contact against the outer surface of the inner casing.

The known sliding element can reduce friction. However, it is a disadvantage that the support of the inner casing and the sliding guidance can in the case of high stress during operation be insufficient over the service life of the steering column.

Thus a need exists to make an improved support and sliding function possible. Especially in the case of an electrically adjustable steering column, in the case of which the longitudinal adjustment of the steering wheel position is effected electrically by an electromotive adjustment drive between the inner casing and the outer casing and robust support and sliding guidance for the inner casing over the service life is particularly important, an improved solution is particularly needed.

### BRIEF DESCRIPTION OF THE FIGURES

So that those skilled in the art to which the subject disclosure appertains will readily understand how to make and use the devices and methods of the subject disclosure without undue experimentation, preferred embodiments thereof will be described in detail herein below with reference to certain figures, wherein:

FIG. 1 shows a schematic perspective view of a steering column.

FIG. 2ashows a longitudinal section through the steering column according to FIG. 1.

FIG. 2bshows a longitudinal section similar to FIG. 2a, the actuating unit being hidden here.

FIG. 3 shows a detail view from FIGS. 2a and 2b.

FIG. 4 shows a cross section Q-Q through the steering column according to FIG. 2a.

FIG. 5 shows a detail view from FIG. 4.

FIG. 6 shows a perspective view of a sliding element.

FIG. 7 shows a further perspective view of the sliding element according to FIG. 6.

FIG. 8 shows a detail view of FIG. 7.

### DETAILED DESCRIPTION

Although certain example methods and apparatus have been described herein, the scope of coverage of this patent is not limited thereto. On the contrary, this patent covers all methods, apparatus, and articles of manufacture fairly falling within the scope of the appended claims either literally or under the doctrine of equivalents. Moreover, those having ordinary skill in the art will understand that reciting “a” element or “an” element in the appended claims does not restrict those claims to articles, apparatuses, systems, methods, or the like having only one of that element, even where other elements in the same claim or different claims are preceded by “at least one” or similar language. Similarly, it should be understood that the steps of any method claims need not necessarily be performed in the order in which they are recited, unless so required by the context of the claims. In addition, all references to one skilled in the art shall be understood to refer to one having ordinary skill in the art.

Some embodiments include a steering column for a motor vehicle, comprising an inner casing of an actuating unit, said inner casing being received so as to be telescopically adjustable in the longitudinal direction axially with respect to a longitudinal axis in a passage of an outer casing, there being fixed to the outer casing at least one sliding element on which the inner casing is slidingly mounted

In the case of a steering column for a motor vehicle, comprising an inner casing of an actuating unit, said inner casing being received so as to be telescopically adjustable in the longitudinal direction axially with respect to a longitudinal axis in a passage of an outer casing, there being fixed to the outer casing at least one sliding element on which the inner casing is slidingly mounted, provision is made according to the invention for the sliding element to be designed in the form of a tube segment elongated in the longitudinal direction.

At least one sliding element is arranged in a radial gap between the outer surface of the inner casing and an inner surface in the passage of the outer casing, and fixed to the outer casing in the longitudinal direction and in the circumferential direction. On its radially inwardly directed inner side, the sliding element has at least one sliding surface which is in sliding contact with the outer surface of the inner casing and slidingly supports said outer surface in the longitudinal direction. On its radially outwardly directed outer side, the sliding element has a supporting surface which is used to support it against the inner surface of the passage.

The tube-segment-like sliding element according to the invention has a tube or hollow profile portion with an arcuate cross section, which is adapted to the radial gap between the inner casing and the outer casing. By definition, the sliding element has a length measured axially, i.e. in the longitudinal direction, and a width measured in the circumferential direction. The width can be indicated by the angle portion measured about the longitudinal axis, or as an arc portion in relation to the outer circumference of the inner casing or the inner circumference of the passage of the outer casing.

The design as a tube segment makes it possible to optimize the supporting and guiding function of the sliding element with relatively little constructional and structural effort. For example, transverse loads and tilting moments acting on the inner casing during operation can be reliably transmitted from the inner casing to the outer casing by increasing the length. The areal support can advantageously increase the natural frequency of the steering column. In addition, there are wider possibilities available in terms of the configuration and arrangement of the sliding surfaces on the sliding element, as a result of which the sliding properties can be specified in a defined manner and optimized with regard to the respective requirements.

It is preferable for the sliding element to be formed in a basic shape which corresponds to that of a hollow cylinder segment. The basic shape of the sliding element arranged in the radial gap between the inner casing and the outer casing corresponds substantially to a cylindrically curved tube segment. This has at least one sliding surface which is arranged radially on the inside, which is preferably internally cylindrically curved and which is in sliding contact with an at least partially cylindrical outer surface of the inner casing. The passage of the outer casing may preferably at least partially have a cylindrical inner surface, against which the sliding element is radially outwardly supported by means of an outer supporting surface which is also at least partially cylindrical.

The hollow-cylindrical, tube-segment-like design makes it possible to realize advantageous areal sliding guidance for a cylindrical inner casing tube.

An advantageous embodiment provides for a plurality of sliding elements to be arranged distributed over the circumference. A plurality of at least two, alternatively also three or more sliding elements, may be arranged distributed over the circumference with respect to the longitudinal axis. In this way, the size of the sliding surface overall can be increased and transverse forces can be accommodated very substantially independently of their direction of action.

A further advantageous embodiment provides that, in addition to the at least one sliding element, at least one pressing spring element for pressing the inner casing against the at least one sliding element is arranged distributed over the circumference. The pressing spring element contains a spring component under preload which may be designed, for example, as a leaf spring or as a helical spring and exerts a compressive force on the inner casing directly or indirectly via further components such that said inner casing is pressed against the sliding element or elements by the compressive force and thus a compressive force (as reaction force) is in turn exerted on the inner casing via the sliding elements. This ensures that compressive force is always applied in various directions of action to the inner casing by all of the sliding elements and pressing spring elements distributed over its circumference and thus a high stiffness of the overall construction forming the steering column is ensured. Deflection of the spring component makes it possible to compensate for any wear of the sliding element or elements over the service life, with the result that the compressive forces distributed over the circumference on the inner casing and thus the stiffness of the steering column can be ensured over the entire service life.

The expression “distributed over the circumference” relates to a distribution over a 360° circular arc along the circumference of the inner or outer casing of the steering column, that is to say along a circle which encircles (and is normal to) the longitudinal axis, wherein the pitch angles between in each case two adjacent elements may all be the same size, or may also be different.

For example, three elements may be distributed over the circumference with three identical pitch angles of in each case 120° with respect to one another, but they may also be distributed for example in such a way that two elements are arranged at an angle of 90° with respect to one another and the third element has a respective pitch angle of 135° with respect to the two other elements. The angles relate in each case to the line of action of the compressive force acting on the inner casing from the respective element.

Advantageously, provision may furthermore be made for a pressing spring element to be arranged on the lower side of the inner casing. The lower side means the angle region along the above-described circular arc along the circumference of the inner and/or outer casing that has an angle not greater than +/−10° downwards with respect to the direction of gravity in the installed state in the vehicle. This arrangement results in the advantage that the weight loading does not cause any undesirable sideways-acting lateral forces in the pressing spring element.

Preferably, each of the sliding elements has a width which is smaller than half the circumference, corresponding to an angle portion of less than 180°. It is also possible for more than one sliding element to be provided.

It is particularly preferable for exactly three sliding elements and/or pressing spring elements to be provided, each extending in the circumferential direction over approximately one third of the circumferential arc, corresponding to a respective angle portion or pitch angle of 120° with a possible deviation of +/−10°.

It is advantageous for the length of a sliding element to be greater than the width thereof. The length is defined as the axial dimension of the tube segment measured in the longitudinal direction. This is preferably greater than the width measured in the circumferential direction. In this way, a sliding element is designed as a strip elongated axially in the direction of the longitudinal axis.

The relatively greater axial length ensures a tilt-proof support against transverse forces and allows a durable guide and an overall stiffer steering column. The width which is relatively smaller with respect thereto allows a defined bearing arrangement, for example a clearly defined three-sided guide between preferably exactly three sliding elements and/or pressing spring elements distributed over the circumference.

It is preferable for the length to correspond to at least 1.5 times the width. It is particularly preferable for the length to correspond to at least double the width.

Provision may preferably be made for a sliding element to have a contact surface extending over a subregion. The contact surface, which is synonymously also referred to as sliding surface, is arranged on the inner side directed radially against the inner casing. It is smaller than the overall area of the sliding element, which is given by the length and width thereof, and is arranged within this overall area. It is formed in such a way that the sliding element is in sliding contact with the inner casing exclusively via the contact surface. To this end, a contact surface may be arranged on a projection or region protruding radially inwardly from the sliding element. In other words, the contact or sliding surface denotes a defined surface portion within the extent of the sliding element in which the actual sliding guidance is effected.

It is possible for one or more contact surfaces to be formed per sliding element. The arrangement of a plurality of contact surfaces makes it possible to adapt the sliding and supporting properties within wide limits. It is for example possible to realize a multi-point bearing system on a sliding element, in order for example to better be able to compensate for tolerances, to adapt the sliding behavior in a variable manner or to realize a spatially defined support. In this way, it is possible, solely by way of the configuration of the sliding element or elements, to optimize the operating properties and to expand the use possibilities.

In the aforementioned embodiment, provision may be made for two contact surfaces to be arranged at a spacing in the longitudinal direction and/or in the circumferential direction on a sliding element. As a result, it is for example possible, by means of an individual sliding element or a single row of sliding elements attached distributed over the circumference, which may for example be formed from exactly three sliding elements distributed over the circumference, to use the contact surfaces, which are separated in the longitudinal direction and/or in the circumferential direction, to realize two three-point or three-surface bearings which are spaced apart in the longitudinal direction. In this way, a clear spatial orientation and bearing of the inner casing relative to the outer casing is possible with little structural effort.

In addition or as an alternative, it is possible for two or more contact surfaces to be arranged spaced apart in the circumferential direction on a sliding element. As a result, it is for example possible for three contact surfaces to be arranged distributed over the circumference on two sliding elements, in order to realize a three-point or three-surface bearing system.

As a development, it is possible for a contact surface to have indentations. The indentations are introduced into a region of the contact surface that lies areally against the outer side of the inner casing, and may have, for example, continuous or interrupted grooves, bowl-like depressions or the like. The direction of the indentations may either be radially outward as seen from the longitudinal axis (or synonymously in a direction normal to the surface of the contact surface) or it may be parallel to a demoulding direction if the sliding element is produced by means of a mould involving demoulding (for example an injection mould). The indentations may extend over the entire contact surface or a subregion.

The indentations may receive lubricant, for example lubricating grease or the like. As a result, they may serve as lubricant reservoir during operation, in order to ensure effective lubrication and thus a smooth-running adjustment.

The indentations may have a rectilinear or a curved shape. Rectilinearly shaped indentations can form a pattern of parallel and/or crossed lines, all or some of which have identical spacings with respect to one another, for example. The lines may be oriented in the longitudinal direction (that is to say parallel to the longitudinal axis) or transverse direction, or they may be oriented obliquely with respect to the longitudinal direction.

It is possible either for all the lines to have the same orientation, or for two groups of lines having two different orientation directions to be present. In the latter case, the lines may form a grid-like pattern, for example similar to a tyre profile. In such a case, the two groups may, for example, be oriented in two differently oriented oblique directions, resulting in the formation of a rhombic pattern. Such an arrangement of rectilinear indentations may be particularly advantageous, since the indentations can then distribute lubricant particularly well over the circumference and a dirt-removing effect can also develop (the edges of the indentations can act as scrapers).

It is advantageous for a sliding element to be supported on its radial outer side at least partially in a form-fitting manner against the outer casing. Due to the fact that the outer side is of at least partially cylindrical form and has the same radius as the passage, the sliding element can lie areally thereagainst. Stable radial positioning and fixing of the sliding element can thus be ensured.

Provision may preferably be made for the sliding element to lie areally against the outer casing and be supported thereagainst substantially over its entire longitudinal extent.

Provision may further preferably be made for the sliding element to have on its radial outer side an axially oriented longitudinal bead which is supported in a form-fitting manner against a corresponding depression in the outer casing. As a result, the positioning and fixing of the sliding element on the outer casing can be stably ensured not only in the radial direction but also in the circumferential direction.

It is preferable for a sliding element to be at least partly formed from plastic. The sliding element may consist, in one piece, of a plastics part or may be an assembly of a plurality of components, at least the part comprising the contact surface(s) consisting of a plastic. Use may preferably be made of a plastic having good sliding properties, for example polyamide, polytetrafluoroethylene or the like. This makes it possible to form a low-friction friction pairing with a metallic surface of the inner casing, which may be manufactured for example from steel.

It is advantageous for the sliding element to have an injection-moulded plastics part composed of a thermoplastic polymer. This allows efficient manufacturing. In particular, the sliding element, including the fastening means and the sliding surfaces with moulded-in depressions, may be provided in one piece. It is also possible, in the region of a contact surface, for plastic to be moulded onto a carrier element composed of a different material.

Provision is preferably made for the sliding element to have on its outer side a fastening element. The fastening element is preferably designed such that it can be fixed to a corresponding fastening means of the outer casing. It may, for example, have one or more radially outwardly protruding form-fitting elements which can engage in corresponding cutouts or openings formed in the inner side of the passage. This makes it possible to generate a form-fitting engagement which acts in the longitudinal direction and circumferential direction, with the result that the radially inwardly sliding sliding element supported against the inner casing is held in a form-fitting manner on all sides.

The fastening element may have a resilient latching element or the like which can snap-fit into a corresponding latching receptacle on the outer casing. The latching element has an undercut geometry which, after the snap-fitting in the latching receptacle, ensures permanent fixing of the sliding element to the outer casing, “permanent” meaning that the fixing can be released again only with an active manual intervention or with a suitable tool. In this way, it is for example ensured that the sliding elements can be mounted in the passage of the outer casing even without an inner casing being present and that the mounted sliding elements cannot fall out in an uncontrolled manner when the inner casing is removed (for example during servicing).

Such snap-fit or latching elements are known in principle, and allow simple, preferably tool-free mounting, and offer reliable fixing.

Provision may particularly preferably be made for the sliding element to have an injection-moulded plastics part and for the sliding element to also have a fastening element with a resilient latching element and a demoulding cutout adjoining the fastening element. Since the latching element has an undercut geometry, this may make the demoulding of the injection-moulded part difficult and/or necessitate a more expensive injection mould with a plurality of demoulding directions. In order to avoid this, a demoulding cutout may be provided adjoining the fastening element, said demoulding cutout being designed as a continuous hole through the sliding element body, the hole pointing, in terms of its direction, from behind at the undercut region of the latching element. This makes it possible to design the injection mould as a simple open-and-shut mould and to fashion the mould split in such a way that the undercut surface of the latching element comes to lie in the parting plane, such that simple demoulding of the injection-moulded part is possible.

A plurality of fastening elements may be provided as required.

It is advantageous for a fastening element to be arranged between two contact surfaces which each extend over a subregion of the sliding element. In the embodiment described further above, the sliding element has two or more separated contact surfaces, the sliding contact being present only at these surfaces. It is advantageous for the sliding element to be fixed to the outer casing outside these contact surfaces. This ensures that the function of the contact surfaces cannot be influenced by holding forces acting on the fastening elements. A substantially symmetrical arrangement, for example in the intermediate space between two contact surfaces which are spaced apart in the longitudinal direction, may be particularly advantageous in this respect.

It is advantageous for a motorized adjustment drive to be arranged between the inner casing and the outer casing. The inner casing has an actuating unit for inputting manual steering commands, preferably by means of a steering wheel which is rotatable about the longitudinal axis. This can be adjusted by adjusting the inner casing relative to the outer casing in the longitudinal direction. The motorized adjustment drive may have a linear drive which is known per se, for example a spindle drive or the like, which engages in the longitudinal direction between the adjustable casings.

In the various figures, identical parts are always provided with the same reference signs, and will therefore generally also be named or mentioned only once in each case.

FIG. 1 shows, from obliquely top right, a steering column 1 according to the invention in a schematic perspective view of the rear end, illustrated in relation to the direction of travel of a vehicle (not illustrated).

The steering column 1 comprises a carrying unit 2 which has fastening means 21 in the form of fastening bores for attachment to a vehicle body (not illustrated). The carrying unit 2 holds the outer casing 4 of a casing unit, said outer casing also being referred to as a guide box or boxed swingarm and receiving an actuating unit 3.

The actuating unit 3 has an inner tube 31 (casing tube) in which a steering spindle 32 is mounted rotatably about a longitudinal axis L, said steering spindle extending axially in the longitudinal direction, i.e. in the direction of the longitudinal axis L. Formed at the rear end of the steering spindle 32 is a fastening portion 33, a steering wheel (not illustrated) being attachable thereto.

In order to realize a longitudinal adjustment, the inner casing 31 is received in the outer casing 4 of the casing unit so as to be telescopically displaceable in the direction of the longitudinal axis L in order to be able to position the steering wheel, connected to the steering spindle 32, forwards and backwards in the longitudinal direction relative to the carrying unit 2, as indicated by the double-headed arrow parallel to the longitudinal axis L.

The outer casing 4 is mounted in a pivot bearing 22 on the carrying unit 2 so as to be pivotable about a horizontal pivot axis S that is transverse to the longitudinal axis L. In the rear region, it is connected to the carrying unit 2 via an actuating lever 41. As a result of a rotational movement of the actuating lever 41 by means of an adjustment drive 65, the outer casing 4 can be pivoted relative to the carrying unit 2 about the pivot axis S that lies horizontally in the installed state, as a result of which it is possible to adjust a steering wheel, attached to the fastening portion 33, in the height direction H, as indicated by the double-headed arrow.

An adjustment drive 5 for longitudinally adjusting the actuating unit 3 relative to the outer casing 4 in the direction of the longitudinal axis L has a spindle drive with a spindle nut 51 into which a threaded spindle 52 extending along its spindle axis G engages, the external thread of said threaded spindle is thus screwed into the corresponding internal thread of the spindle nut 51. The spindle axis G runs substantially parallel to the longitudinal axis L.

The spindle nut 51 is mounted rotatably about the spindle axis G in a drive housing 53 of a drive unit 55, said drive housing being fixedly connected to the outer casing 4. In the direction of the spindle axis G, the spindle nut 51 is axially supported on the outer casing 4 via the drive unit 55.

By means of a fastening element, the joint head 54, formed at the rear end of the threaded spindle 52, the latter is connected to the inner casing 31 of the actuating unit 3 via a transmission element 34, specifically in a manner fixed in the direction of the axis G or the longitudinal axis L and stationary in respect of rotation about the axis G. As a result of the spindle nut 51 that is driveable to rotate and the threaded spindle 52 that is stationary in respect of rotation, what is known as a plunger spindle drive is realized.

The transmission element 34 extends from the actuating unit 3 through a slot 42 in the outer casing 4. In order to adjust the steering column 1 in the longitudinal direction, the transmission element 34 can be freely moved along in the longitudinal direction in the slot 42.

The adjustment drive 5 has a drive unit 55 with an electrical actuating motor, by means of which the spindle nut 51 is driveable to rotate with respect to the axis G1 relative to the stationary threaded spindle 52 relative to the drive housing 53. As a result, it is possible—depending on the direction of rotation of the actuating motor—to displace the threaded spindle 52 in the direction of the spindle axis G in a translational manner relative to the spindle nut 51 such that, accordingly, the inner casing 31, connected to the threaded spindle 52, of the actuating device 3 is adjusted in the direction of the longitudinal axis L relative to the outer casing 4 connected to the spindle nut 51.

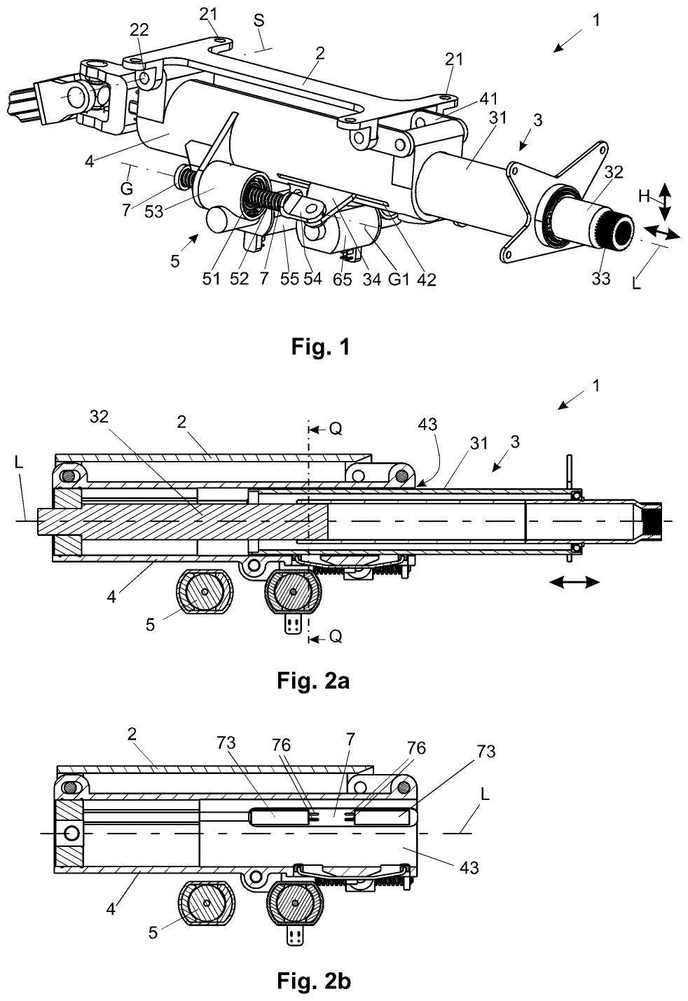

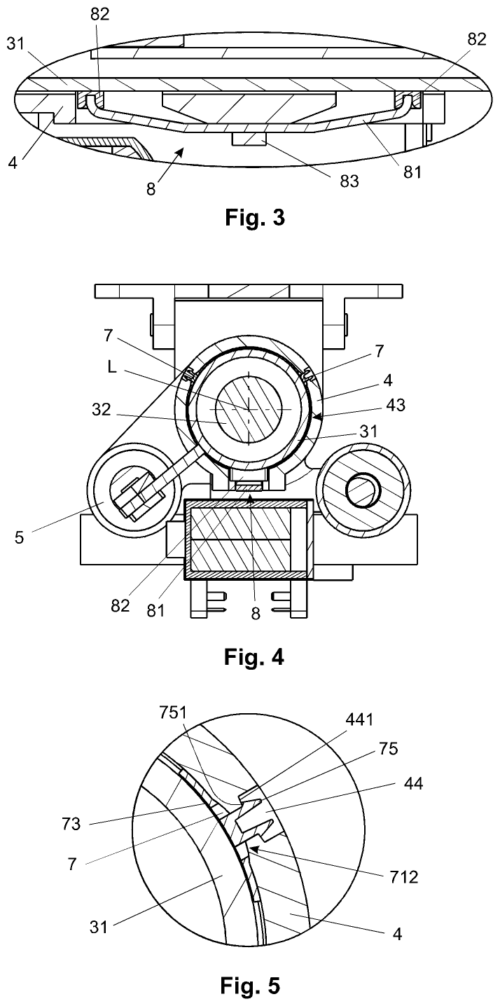

FIG. 2a shows a longitudinal section through the steering column 1 along the longitudinal axis L. In FIG. 2b, the actuating unit 3 is omitted in the same view. FIG. 3 shows an enlarged detail view of FIGS. 2a and 2b. FIG. 4 shows a cross section Q-Q from FIG. 2a, and FIG. 5 shows an enlarged detail view from FIG. 4.

FIG. 2a shows how the inner casing 31 of the actuating unit 3 is received in a passage 43 of the outer casing 4 so as to be telescopically adjustable in the longitudinal direction, as indicated by the double-headed arrow.

The actuating unit 3 has been omitted in FIG. 2b, such that there is a clear view of the inner side of the passage 43. As a result, one of the sliding elements 7 arranged in the outer casing 4 can be seen.

It can be gathered from the cross section Q-Q in FIG. 4 that the inner casing 31 is of externally cylindrical form, and the passage 43 of the outer casing 4 is of internally cylindrical form adapted thereto.

In the example shown, a total of two sliding elements 7 designed according to the invention and one pressing spring element 8 are fixed to the outer casing 4 in a radially inwardly directed manner in the passage 43, and are attached so as to be approximately uniformly distributed over the circumference in a triangular arrangement.

In the installation position according to FIG. 4, the pressing spring element 8 lies, from below, in sliding contact against the outer surface of the inner casing 31, as illustrated in FIG. 3. As a result of this arrangement on the lower side of the inner casing 31, the pressing spring element 8 can accommodate the weight forces of the inner casing 31 directly and centrally and thus does not require any further lateral support. The pressing spring element 8 contains a spring element 81 which is designed as a leaf spring, exerts compressive force on the inner casing 31 via two sliding shoes 82 and is supported on the outer casing 4 via a support element 83.

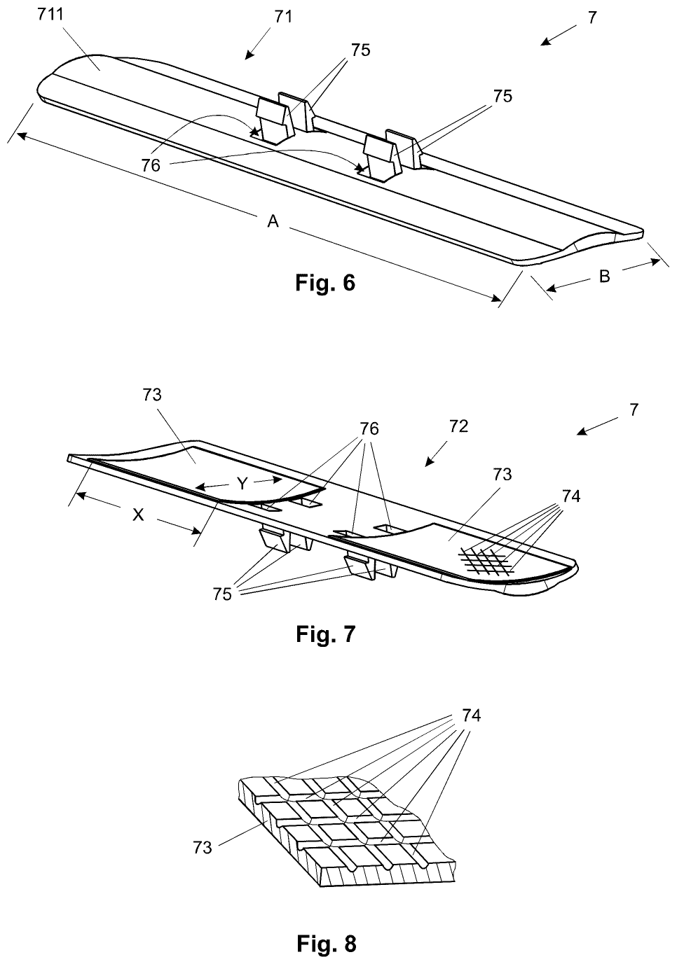

The two sliding elements 7 are arranged offset relative to the pressing spring element 8 and to one another with respect to the longitudinal axis L by approximately 120° in the radial gap between the inner casing 31 and the outer casing 4. They are of identical form, according to the illustrations in FIGS. 6, 7 and 8.

The sliding element 7 illustrated in each case individually in an exposed manner in FIGS. 6 and 7 is designed as a one-piece plastics part, preferably as an injection-moulded plastics part. FIG. 6 shows a view of the radially outwardly directed outer side 71, and FIG. 7 shows a view of the radially inwardly directed inner side 72.

The sliding element 7 has a length A measured in the longitudinal direction, and a width B measured in the circumferential direction. The length A is considerably greater than the width B, preferably at least 1.5 times as great, particularly preferably at least twice as great.

According to the invention, the sliding element 7 has a tube-segment-like basic shape, which in the example shown is designed as a hollow-cylindrical profile segment. The curvature of the inner side 72 is adapted to the outer radius of the inner casing 31. Furthermore, the curvature of the outer side 71 is adapted to the inner radius of the outer casing 4. In addition thereto, the outer side 71 also has an additional bead 711. Provided in the outer casing 4 is a corresponding recess 712 into which the bead 711 nestles, such that overall a form-fitting support of the sliding element 7 against the outer casing 4 is provided. This can be seen in FIG. 5, which illustrates the installation position according to FIG. 4 in enlarged form.

The sliding element 7 has two contact surfaces 73, which are formed separately and each have a length X in the longitudinal direction and a width Y in the circumferential direction, which taken in isolation are each smaller than the length A and the width B of the sliding element 7. Accordingly, each contact surface 73 extends over a subregion of a sliding element 7. The two contact surfaces 73 are spaced apart from one another in the longitudinal direction and protrude radially inwardly from the inner side 72.

The sliding elements 7 are in sliding contact with the outer side of the inner casing 31 exclusively in the region of the contact surfaces 73.

The contact surfaces 73 may optionally be provided with indentations 74, which in the example shown have grooves running in a cross-like manner. These are shown in an enlarged detail view in FIG. 8.

Protruding radially outwardly from the outer side 71 are fastening elements 75 which have resilient latching elements and can latch or snap-fit in a form-fitting manner into corresponding latching receptacles 44, for example continuous latching openings, as can be seen in FIG. 5.

The form-fitting engagement comes about as a result of an undercut geometry or undercut 751 on the latching element or on the fastening element 75, said undercut geometry or undercut being supported on a shoulder 441 of the latching receptacle.

The sliding element 7 is designed as an injection-moulded part and can, in spite of the undercut geometry 751 present on the fastening elements 75, be produced by a simple and cost-effective open-and-shut mould without lateral slides or ejectors, since said sliding element has adjoining the fastening elements 75 demoulding cutouts 76, through which pins contained in the mould through the sliding element 7 from the inner side thereof the undercut geometry can be formed from the rear side.

The fastening elements 75 are arranged in the longitudinal direction between the contact surfaces 73, as can be seen in FIGS. 2a and 7.

### LIST OF REFERENCE SIGNS

1 Steering column
2 Carrying unit
21 Fastening means
22 Pivot bearing
3 Actuating unit
31 Inner casing
32 Steering spindle
33 Fastening portion
34 Transmission element
4 Outer casing
41 Actuating lever
42 Slot
43 Passage
44 Latching receptacle
441 Shoulder
5 Adjustment drive
51 Spindle nut
52 Threaded spindle
53 Drive housing
54 Joint head (fastening element)
55 Drive unit (actuating motor)
65 Adjustment drive
7 Sliding element
71 Outer side
711 Bead
712 Recess in the outer casing
72 Inner side
73 Contact surface
74 Indentation
75 Fastening element
751 Undercut geometry, undercut
76 Demoulding cutout
8 Pressing spring element
81 Spring element
82 Sliding shoe
83 Support element
L Longitudinal axis
S Pivot axis
H Height direction
G Spindle axis
A Length of the sliding element 7
B Width of the sliding element 7
X Length of the contact surface 73
Y Width of the contact surface 73

1. A steering column for a motor vehicle, comprising:
an inner casing of an actuating unit, said inner casing being received so as to be telescopically adjustable in the longitudinal direction axially with respect to a longitudinal axis in a passage of an outer casing, there being fixed to the outer casing at least one sliding element on which the inner casing is slidingly mounted;
wherein the sliding element is a tube segment elongated in the longitudinal direction.

2. The steering column according to claim 1, wherein a plurality of sliding elements are arranged distributed over the circumference.

3. The steering column according to claim 1, wherein, in addition to the at least one sliding element, at least one pressing spring element for pressing the inner casing against the at least one sliding element is arranged distributed over the circumference.

4. The steering column according to claim 3, wherein a pressing spring element is arranged on the lower side of the inner casing.

5. The steering column according to claim 1, wherein the length of a sliding element is greater than the width thereof.

6. The steering column according to claim 1, wherein a sliding element has a contact surface extending over a subregion.

7. The steering column according to claim 6, wherein two contact surfaces are arranged at a spacing in the longitudinal direction and/or in the circumferential direction on a sliding element.

8. The steering column according to claim 6, wherein a contact surface has indentations.

9. The steering column according to claim 1, wherein a sliding element is supported on its radial outer side at least partially in a form-fitting manner against the outer casing.

10. The steering column according to claim 1, wherein a sliding element is at least partly formed from plastic.

11. The steering column according to claim 1, wherein the sliding element has an injection-moulded plastics part composed of a thermoplastic polymer.

12. The steering column according to claim 1, wherein the sliding element has on its outer side a fastening element.

13. The steering column according to claim 12, wherein the sliding element has an injection-moulded plastics part and the sliding element also has a fastening element with a resilient latching element and a demoulding cutout adjoining the fastening element.

14. The steering column according to claim 12, wherein a fastening element is arranged between two contact surfaces which each extend over a subregion of the sliding element.

15. The steering column according to claim 1, wherein a motorized adjustment drive is arranged between the inner casing and the outer casing.
